(19) United States
(12) Patent Application Publication
(10) Pub. No.: US 2026/0205864 A1
(43) Pub. Date: Jul. 16, 2026

(54) PEER-TO-PEER LOW LATENCY TRAFFIC IN ENHANCED TRANSMISSION OPPORTUNITIES

(71) Applicant: Samsung Electronics Co., Ltd., Suwon-si (KR)

(72) Inventors: Yue Qi, Plano, TX (US); Peshal Nayak, Plano, TX (US); Rubayet Shafin, Frisco, TX (US); Boon Loong Ng, Plano, TX (US); Vishnu Vardhan Ratnam, Frisco, TX (US); Bilal Sadiq, Plano, TX (US)

(21) Appl. No.: 19/449,296

(22) Filed: Jan. 14, 2026

Related U.S. Application Data
(60) Provisional application No. 63/746,115, filed on Jan. 16, 2025.
(60) Provisional application No. 63/763,729, filed on Feb. 26, 2025.

(51) Int. Cl. H04W 28/02; H04W 74/0808; H04W 84/12

(52) U.S. Cl. CPC H04W 28/0236; H04W 74/0808; H04W 84/12

(57) ABSTRACT

Methods and systems for peer-to-peer in enhanced reverse direction grant. A method performed by a transmission opportunity (TXOP) responder device includes receiving a frame from a TXOP initiator device. The method also includes generating a message including buffered low latency peer-to-peer (P2P) traffic and a P2P indication during a reverse direction grant (RD grant) procedure or a TXOP duration in response to the TXOP initiator device. The method also includes transmitting the message to the TXOP initiator device. A method performed by a TXOP initiator device includes transmitting a frame to a TXOP responder device. The method also includes receiving a message from the TXOP responder device, wherein the message includes buffered low latency P2P traffic and P2P indication during an RD grant procedure or a TXOP duration.

### CROSS-REFERENCE TO RELATED APPLICATIONS AND CLAIM OF PRIORITY

The present application claims priority to U.S. Provisional Patent Application No. 63/746,115, filed on Jan. 16, 2025 and to U.S. Provisional Patent Application No. 63/763,729, filed on Feb. 26, 2025. The contents of the above-identified patent documents are incorporated herein by reference.

### TECHNICAL FIELD

The present disclosure relates generally to wireless communication systems. more specifically, the present disclosure relates to a system and method for peer-to-peer low latency traffic in enhanced transmission opportunities.

### BACKGROUND

Wireless local area network (WLAN) technology allows devices to access the internet in the 2.4 GHZ, 5 GHZ, 6 GHZ, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among users of mobile data devices, such as smart phones, tablets, “note pad” computers, net books, eBook readers, and machine type of devices. To address the issue of increasing bandwidth requirements demanded of wireless communications systems, different schemes are being developed to allow multiple user terminals to communicate with a single access point by sharing channel resources while achieving high data throughputs, such as by using Multiple Input Multiple Output (MIMO) technology.

### SUMMARY

The present disclosure relates generally to wireless communication systems and, more specifically, the present disclosure relates to a system and method for peer-to-peer low latency traffic in enhanced transmission opportunities.

In one embodiment, a performed by a transmission opportunity (TXOP) responder device is provided. The method includes receiving data from a TXOP initiator device. The method also includes generating a message including buffered low latency peer-to-peer (P2P) traffic and a P2P indication during a reverse direction (RD) grant (RD) procedure or a TXOP duration in response to the TXOP initiator device. The method also includes transmitting the message to the TXOP initiator device.

In another embodiment, a method performed by a TXOP initiator device is provided. The method includes transmitting a frame to a TXOP responder device. The method also includes receiving a message from the TXOP responder device, wherein the message includes buffered low latency P2P traffic and a P2P indication during a RD grant procedure or a TXOP duration.

In yet another embodiment, an electronic device is provided. The electronic device includes at least one processor including processing circuitry and a memory storing instructions. The instructions, when executed by the at least one processor individually or collectively, cause the electronic device to receive data from a TXOP initiator device. The instructions, when executed by the at least one processor individually or collectively, also cause the electronic device to generate a message including buffered low latency P2P traffic and a P2P indication during an RD grant procedure or a TXOP duration in response to the TXOP initiator device. The instructions, when executed by the at least one processor individually or collectively, also cause the electronic device to transmit the message to the TXOP initiator device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP device according to embodiments of the present disclosure;

FIG. 2B illustrates an example STA according to embodiments of the present disclosure;

FIG. 3 illustrates an example enhanced reverse direction grant process with a peer-to-peer grant according to embodiments of the present disclosure;

FIG. 4 illustrates an example enhanced reverse direction grant process with a peer-to-peer grant according to embodiments of the present disclosure;

FIG. 5 illustrates an example transmission opportunity enabling peer-to-peer communication according to embodiments of the present disclosure;

FIG. 6 illustrates an example transmission opportunity enabling peer-to-peer communication according to embodiments of the present disclosure;

FIG. 7 illustrates an example flow chart of a method for wireless communication performed by a transmission opportunity responder device according to embodiments of the present disclosure; and

FIG. 8 illustrates an example flow chart of a method for wireless communication performed by a transmission opportunity initiator device according to embodiments of the present disclosure.

### DETAILED DESCRIPTION

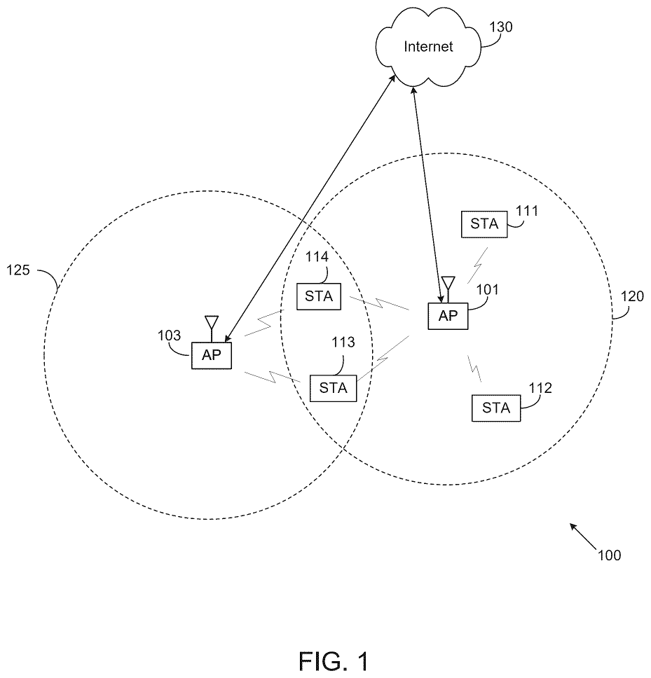

FIG. 1 through FIG. 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, wireless local area network (WLAN) technology allows devices to access the internet in the 2.4 GHZ, 5 GHZ, 6 GHZ, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

When a wireless device such as a non-AP device STA is associated with an access point, the device transmits measurement reports, sends data, and receives data through the associated access point. The device addresses frames, including channel state information measurement reports and compressed beamforming reports, to the associated access point, which is the sole intended recipient. The device configures its transmissions for proper reception at the associated access point and does not additionally configure those transmissions for reception at any unassociated access point.

Multiple access points, for example neighboring access points operating on at least one common channel, may coordinate to improve system performance in areas such as data rate, reliability, and latency. For example, two or more access points may coordinate beamforming or precoding decisions for simultaneous transmissions so that each access point can serve its associated STA while reducing interference to the STA served by the other access point at the same time. In another example, two or more access points may coordinate to achieve spatial reuse of the channel by transmitting them to their respective associated STA s that are partly shielded from the other access point because of current channel conditions, the environment, or relative locations.

However, current iterations of reverse direction (RD) grant or TXOP do not adequately support low-latency traffic. Once a TXOP has been obtained, there is no mechanism for users, including the RD or TXOP responder device, to provide a sufficient variety of low-latency feedback types available to the RD responder device. For example, the RD responder device is limited by the access category and by the types of traffic that can be transmitted. After the RD initiator device obtains a TXOP, the RD responder device lacks a mechanism to signal traffic needs involving a third party, for example, to request peer-to-peer traffic (P2P). The present disclosure provides for an indication to allow P2P communication in an enhanced RD grant process.

Accordingly, the present disclosure provides systems and methods for peer-to-peer in enhanced reverse direction grant. As described herein, the present disclosure includes systems and methods that include transmitting a P2P indication during an RD grant process to allow for a P2P frame exchange. The P2P indication allows for a variety of low-latency feedback types to be made available to the RD responder device.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of STAs 111-114 within a coverage area 120 of the AP device 101. The AP devices 101-103 may communicate with each other and with the STAs 111-114 using Wi-Fi or other WLAN communication techniques.

Depending on the network type, other well-known terms may be used instead of “access point” or “AP device,” such as “router” or “gateway.” For the sake of convenience, the term “AP device” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP device STA.

In various embodiments of this disclosure, each of the AP devices 101 and 103 and each of the STAs 111-114 may be an MLD. In such embodiments, AP devices 101 and 103 may be AP device MLDs, and STAs 111-114 may be non-AP device MLDs. Each MLD is affiliated with more than one STA. For convenience of explanation, an AP device MLD is described herein as affiliated with more than one AP device (e.g., more than one AP device STA), and a non-AP device MLD is described herein as affiliated with more than one STA (e.g., more than one non-AP device STA).

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for facilitating configuring a transmission for reception at an associated STA and an unassociated STA. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

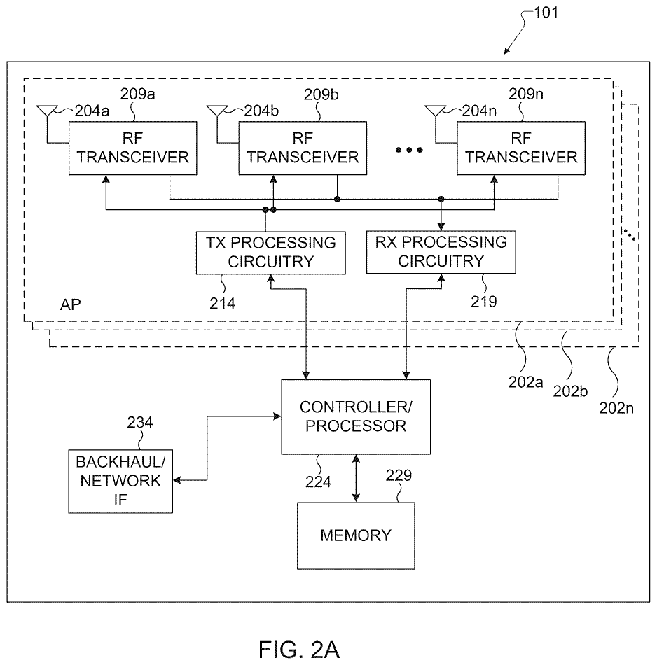

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. In the embodiments discussed herein below, the AP device 101 is an AP device MLD. However, AP devices come in a wide variety of configurations, and FIG. 2A does not limit the scope of this disclosure to any particular implementation of an AP device.

The AP device MLD 101 is affiliated with multiple AP devices 202a-202n (which may be referred to, for example, as AP1-APn). Each of the affiliated AP devices 202a-202n includes multiple antennas 204a-204n, multiple RF transceivers 209a-209n, transmit (TX) processing circuitry 214, and receive (RX) processing circuitry 219. The AP device MLD 101 also includes a controller/processor 224, a memory 229, and a backhaul or network interface 234.

The illustrated components of each affiliated AP device 202a-202n may represent a physical (PHY) layer and a lower media access control (LMAC) layer in the open systems interconnection (OSI) networking model. In such embodiments, the illustrated components of the AP device MLD 101 represent a single upper MAC (UMAC) layer and other higher layers in the OSI model, which are shared by all of the affiliated AP devices 202a-202n.

For each affiliated AP device 202a-202n, the RF transceivers 209a-209n receive, from the antennas 204a-204n, incoming RF signals, such as signals transmitted by STAs in the network 100. In some embodiments, each affiliated AP device 202a-202n operates at a different bandwidth, e.g., 2.4 GHz, 5 GHZ, or 6 GHZ, and accordingly the incoming RF signals received by each affiliated AP device may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP device 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP device 202a-202n operates at a different bandwidth, e.g., 2.4 GHZ, 5 GHZ, or 6 GHz, the outgoing RF signals transmitted by each affiliated AP device may be at a different frequency of RF.

The controller/processor 224 can include one or more processors or other processing devices that control the overall operation of the AP device MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP device MLD 101 by the controller/processor 224 including facilitating transmission for reception at an associated AP and an unassociated AP. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP device MLD 101 to communicate with other devices or systems over a backhaul connection or over a network. The interface 234 could support communications over any suitable wired or wireless connection(s). For example, the interface 234 could allow the AP device MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP device MLD 101 may include circuitry and/or programming for configuring a transmission for reception at an associated STA and an unassociated STA. Although FIG. 2A illustrates one example of AP device MLD 101, various changes may be made to FIG. 2A. For example, the AP device MLD 101 could include any number of each component shown in FIG. 2A. As a particular example, an AP device MLD 101 could include a number of interfaces 234, and the controller/processor 224 could support routing functions to route data between different network addresses. As another particular example, while each affiliated AP device 202a-202n is shown as including a single instance of TX processing circuitry 214 and a single instance of RX processing circuitry 219, the AP device MLD 101 could include multiple instances of each (such as one per RF transceiver) in one or more of the affiliated AP devices 202a-202n. Alternatively, only one antenna and RF transceiver path may be included in one or more of the affiliated AP devices 202a-202n, such as in legacy AP devices. Also, various components in FIG. 2A could be combined, further subdivided, or omitted and additional components could be added according to particular needs.

FIG. 2B illustrates an example non-AP device MLD 111 according to various embodiments of this disclosure. The embodiment of the non-AP device MLD 111 illustrated in FIG. 2B is for illustration only, and the STAs 111-115 of FIG. 1 could have the same or similar configuration. In the embodiments discussed herein below, the STA 111 is a non-AP device MLD.

However, STAs come in a wide variety of configurations, and FIG. 2B does not limit the scope of this disclosure to any particular implementation of an STA.

The non-AP device MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP device MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP device MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP device of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHZ, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP device MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate configuring a transmission for reception at an associated AP device and an unassociated AP device. In some embodiments, the controller/processor 240 includes at least one microprocessor or microcontroller.

The processor 240 is also capable of executing other processes and programs resident in the memory 260, such as operations for facilitating transmission for reception at an associated AP and an unassociated AP. The controller/processor 240 can move data into or out of the memory 260 as required by an executing process. In some embodiments, the controller/processor 240 is configured to execute a plurality of applications 262, such as applications for facilitating transmission for reception at an associated AP and an unassociated AP. The controller/processor 240 can operate the plurality of applications 262 based on the OS program 261 or in response to a signal received from an AP device. The main controller/processor 240 is also coupled to the I/O interface 245, which provides non-AP device MLD 111 with the ability to connect to other devices such as laptop computers and handheld computers. The I/O interface 245 is the communication path between these accessories and the main controller 240.

The processor 240 is also coupled to the touchscreen 250 and the display 255. The operator of the non-AP device MLD 111 can use the touchscreen 250 to enter data into the non-AP device MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP device MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP device 101. In another example, the non-AP device MLD 111 may not include voice communication or the controller/processor 240 could be divided into multiple processors, such as one or more central processing units (CPUs) and one or more graphics processing units (GPUs). Also, while FIG. 2B illustrates the non-AP device MLD 111 configured as a mobile telephone or smartphone, non-AP device MLDs can be configured to operate as other types of mobile or stationary devices.

In Wi-Fi standards, significant attention has been directed to reducing channel access delay for low-latency traffic required by real-time applications. The PAR for IEEE 802.11bn states an intent to define at least one mode of operation that improves the tail of the latency distribution and jitter compared to Extremely High Throughput MAC/PHY operation. Reducing latency to meet the growing demand for real-time applications is therefore a central objective in 802.11bn. The need for 802.11bn reflects more stringent performance requirements to support emerging applications, such as metaverse services, augmented and virtual reality, robotics, industrial automation for industrial IoT, logistics, and smart agriculture. Lower latency directly improves user experience, with particular emphasis on worst-case latency and jitter. Low-latency communication is a foundational requirement for real-time applications. Some use cases require latency below, for example, 5 milliseconds and jitter below 2 milliseconds.

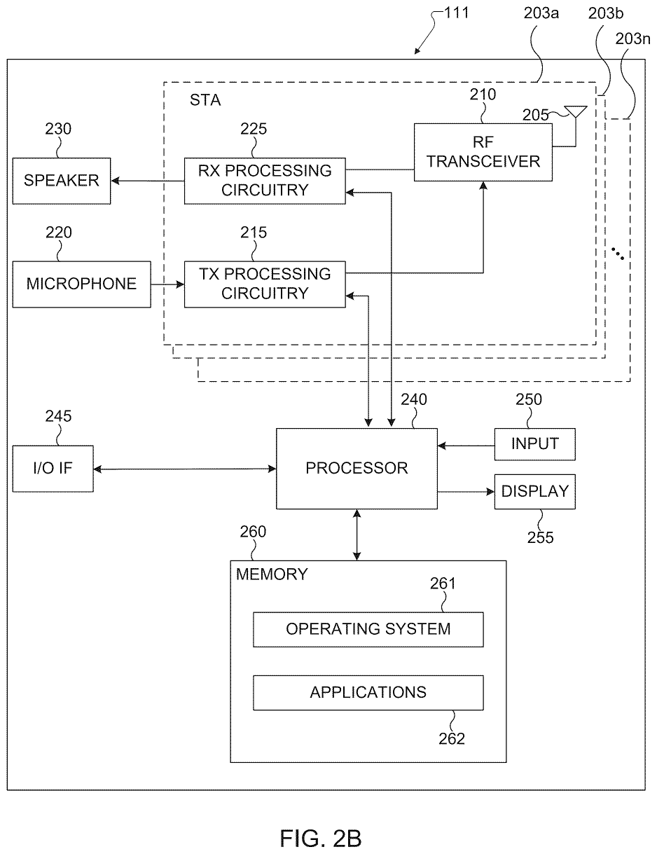

Current iterations of reverse direction (RD) grant or TXOP do not adequately support low-latency traffic. Once a TXOP has been obtained, there is no mechanism for users, including the RD or TXOP responder device, to provide a sufficient variety of low-latency feedback types available to the RD responder device. For example, the RD responder device is limited by the access category and by the types of traffic that can be transmitted. After the RD initiator device obtains a TXOP, the RD responder device lacks a mechanism to signal traffic needs involving a third party, for example, to request peer-to-peer traffic (P2P). The present disclosure provides for an indication to allow P2P communication in an enhanced RD grant process. The specific information elements and signaling procedures for such an indication are discussed regarding FIGS. 3-8 below.

FIG. 3 illustrates an example enhanced RD grant process 300 with a peer-to-peer grant according to embodiments of the present disclosure. For ease of explanation, the enhanced RD grant process 300 will be described as including one or more components of the wireless network 100 of FIG. 1; however, the enhanced RD grant process 300 could be implemented using any other suitable device or system. The embodiment of the enhanced RD grant process 300 shown in FIG. 3 is for illustration only. Other embodiments of the enhanced reverse direction grant process 300 could be used without departing from the scope of this disclosure.

As shown in FIG. 3, the RD grant process 300 includes an RD initiator device 310, an RD responder device 320, and a second STA 330 communicating over a TXOP duration 302. For example, the RD initiator device 310 may transmit frame 312 to the RD responder device 320. To initiate an RD grant with P2P indication, the RD initiator device 310 may transmit a message 314 with a block acknowledgment request (BAR) 316 to the RD responder device 320. The message 314 includes a P2P indication. The P2P indication includes a request for traffic that includes uplink (UL) traffic to a RD initiator device (such as the RD initiator device 310), UL traffic to TXOP initiator device, P2P traffic to an RD responder device, P2P traffic to the STA of the third-party device, a dynamic unavailability operation, or a combination thereof. The P2P indication also may include a feedback field that indicates a feedback type requested by the RD responder device 320. For example, the feedback type indicates the traffic is for a third party or if the traffic is between the device and an associated device

In response the RD responder device 320 may transmit a block acknowledgment (BA) 322 as an indication of a P2P frame exchange 340. The BA 322 may be a multi-STA BA and is used to indicate delivery of traffic outside of the RD grant procedure Upon transmitting the BA 322, the P2P frame exchange 340 may include a P2P data 324 to the second STA 330. The second STA 330 may respond to the P2P data 324 with a second STA BA 332. After the P2P frame exchange 340, the RD responder device 320 may transmit a frame 326 to the RD initiator device 310 (such as to indicate the end of the P2P frame exchange 340) where the RD initiator device 310 may respond with a BA 318.

According to one embodiment, an RD responder device 320 may request P2P activity or co-existence activity with a second STA 330 during the RD grant process 300. The request or indication may appear in a control frame such as a BA 322. As indicated above, the indication may include a Third-Party Feedback type field within the RD grant, and an example of the traffic appears in Table 1. The feedback types that a non-AP STA acting as an RD responder device 320 may request include uplink traffic to an AP acting as the RD initiator device 310, uplink traffic to a second STA 330 that is an AP, P2P traffic involving the RD non-AP responder device, P2P traffic with a second STA 330 that is a non-AP STA, and dynamic unavailability operation. When a non-AP STA acting as the RD responder device 320 sends the indication, the Third-Party Feedback type field may identify the feedback types listed above.

According to one embodiment, the feedback type may be indicated with one bit, where a value of 1 indicates traffic for a second STA 330 and a value of 0 indicates traffic between the RD entities. In another variant, two bits may indicate the above traffic, such as by using a two-bit field to describe the feedback types. As another example, the two bits may be placed in two or more different frames.

TABLE 1
Feedback type Indication

| Information items | Description | Encoding |
|---|---|---|
| Third party traffic | The traffic that a non-AP STA | According to one |
| | RD responder device may | embodiment, the encoding |
| | request for communication | bitmap can be a one-bit |
| | with a third party which is not | indication for third party |
| | the RD initiator device. | traffic. |
| Unavailability | The traffic that a non-AP STA | The signaling can be similar |
| information field | RD responder device may | to that for dynamic |
| | indicate to the RD initiator | unavailability operation |
| | device using an ICR for | (DUO) in the multi-STA BA. |
| | unavailability activities. | |

In another embodiment, a P2P activity or co-existence activity may be labeled with one bit, such as by reserving a special User Info field with a specific AID to indicate P2P activity. A special TID may also indicate P2P traffic. In another embodiment, an ICR frame, such as a BA 322, may deliver information for traffic outside the RD grant where unavailability information may include co-existence, P2P, or other activities. In another embodiment, a Special User Info field with a specific AID or TID may carry co-existence unavailability information during the RD grant in an initial control frame such as a BA 322.

The RD initiator device 310, such as a non-AP STA, may indicate a request for P2P or co-existence activity, or a TXOP request that involves a second STA 330. The RD responder device 320 may transmit a low latency (LL) physical layer protocol data unit (PPDU) after the indication frame. A second STA 330 may be a non-AP STA for P2P or co-existence use cases, and a second STA 330 may also be an AP STA for uplink traffic or other activities. There may be more than one second STA 330 involved in these activities. One or more second STA 330s may associate with the RD initiator device 310 AP, and one or more second STA 330s may register the RD grant with the initiator device.

According to one embodiment, the RD initiator device 310 may decode the header of the LL PPDU so that both the RD initiator device 310 and the second STA 330 become aware of the start of P2P traffic or traffic involving a second STA 330. The header may include provider aggregable identifiers (PAID), a basic service set identifier (BSSID), a direction for the traffic, a third-party traffic field, or a combination thereof. The RD responder device 320 may also indicate a requested duration for P2P transmission. After completion of the P2P or co-existence activity, the RD responder device 320 may return the TXOP to the RD initiator device 310. One example of returning the TXOP is transmission of a Frame, a QoS Null PPDU, or a CF-End frame.

In these embodiments, the RD initiator device 310 may be an AP or a non-AP STA. The RD initiator device 310 may include a third-party support field in a control frame such as a BAR, and the same information may also appear in an aggregated PPDU with an implicit BAR. When the RD initiator device 310 agrees to support the RD responder device 320 for P2P or other activities outside the current RD grant, the RD initiator device 310 may set the third-party support field to 1; otherwise, the field may be set to 0. An example of the third-party support field appears in Table 2.

TABLE 2
Third-Party or Unavailability Support Field

| Information items | Description | Encoding |
|---|---|---|
| Third party traffic | A field in the RD initiator | According to one |
| support field | device which may support the | embodiment, the encoding |
| | transmission between or | bitmap can be a one-bit |
| | among RD responder device | indication in the RD |
| | and a third party. | initiator device. |
| Unavailability | A field in the RD initiator | The signaling can be |
| support field | device which may support the | embedded into the BA |
| | Unavailability activities of the | request frame for dynamic |
| | RD responder device during | unavailability operation |
| | RD grant. | (DUO) support. |

The RD initiator device 310 may support the capability, such as by setting the third-party support field in the RD initiator device 310 to 1. In another embodiment, a Special User Info field with a specific AID or TID may carry a capability indicator for co-existence unavailability information or an unavailability support field during the RD grant on the RD initiator device 310 side, such as in a BAR frame. In one embodiment, the RD initiator device 310 may know the direction or the type of the transmission. In another embodiment, the RD initiator device 310 may not be aware of the traffic requested by the RD responder device 320, although the RD initiator device 310 may know the urgency or LL requirements.

According to one embodiment concerning third-party behavior, a second STA 330 may receive data from an RD responder device 320 where the header includes a special information field, and the second STA 330 may reply with a special header that the RD initiator device 310 can decode. In one example of such an embodiment, the third-party acknowledgment may include the Third-Party Traffic field, PAID, and BSSID, such as by the second STA 330. The second STA 330 may be a non-AP STA for P2P or co-existence use cases, and a second STA 330 may also be an AP STA for uplink traffic or other activities. There may be more than one second STA 330 for these activities, with one or more second STA 330s associated with the RD initiator device 310 AP and one or more second STA 330s registered for the RD grant with the initiator device.

Although FIG. 3 illustrates an example enhanced RD grant process 300 with a peer-to-peer grant, various changes may be made to FIG. 3. For example, various components of FIG. 3 could be combined, further subdivided, or omitted and additional components could be added according to particular needs.

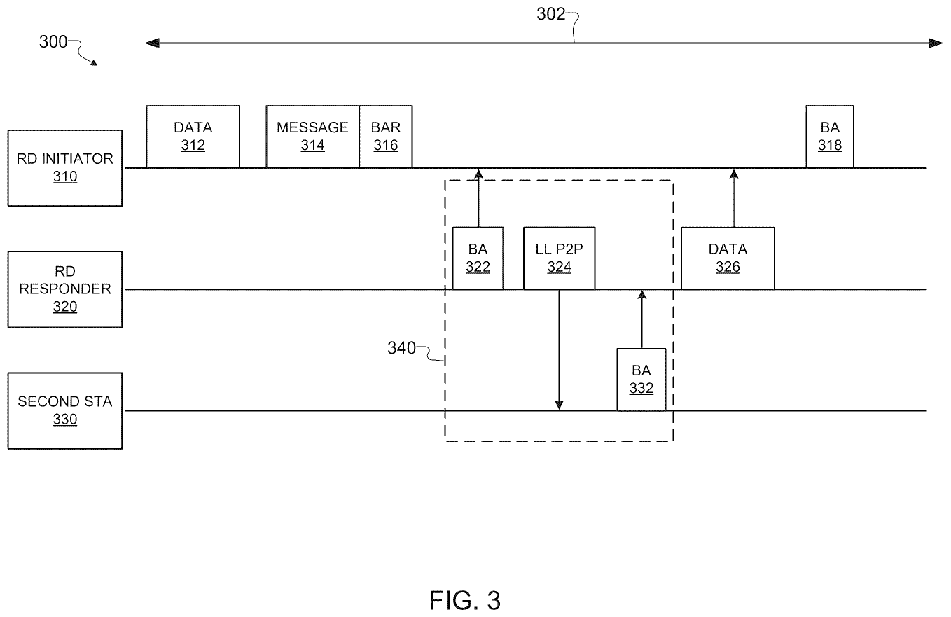

FIG. 4 illustrates an example enhanced RD grant process 400 with a peer-to-peer grant according to embodiments of the present disclosure. For ease of explanation, the enhanced RD grant process 400 will be described as including one or more components of the wireless network 100 of FIG. 1; however, the enhanced RD grant process 400 could be implemented using any other suitable device or system. The embodiment of the enhanced RD grant process 400 shown in FIG. 4 is for illustration only. Other embodiments of the enhanced RD grant process 400 could be used without departing from the scope of this disclosure. The RD grant process 400 is configured similarly to the RD grant process 300, except as otherwise described.

As shown in FIG. 4, the RD grant process 400 includes an RD initiator device 410, an RD responder device 420, and a second STA 430 communicating over a TXOP duration 402. For example, the RD initiator device 410 may transmit frame 412 to the RD responder device 420. To initiate an RD grant with P2P indication, the RD initiator device 410 may transmit a message 414 with a BAR 416 to the RD responder device 420. In response the RD responder device 420 may transmit a BA 422 as an indication of a P2P frame exchange 440. Upon transmitting the BA 422, the P2P frame exchange 440 may include an unavailability co-ex 424 where the RD responder device 420 is unavailable to the RD initiator device 410 due to a frame exchange with the second STA 430, such as for DL or MAP coordination. After the P2P frame exchange 440, the RD responder device 420 may transmit a data 426 to the RD initiator device 410 (such as to indicate the end of the P2P frame exchange 440) where the RD initiator device 410 may respond with a BA 418.

According to one embodiment, when an AP acts as an RD responder device 420 and a non-AP acts as the RD initiator device 410, decision-making remains with the AP. The AP may request a TXOP for a downlink low-latency PPDU. The AP may request a TXOP to trigger a second STA 430 for uplink PPDU. The AP may share a portion of a TXOP with another STA. The AP may also conduct a coordination transmission with another AP. For example, an AP as the RD initiator device 410 may request a downlink low-latency PPDU, perform coexistence exchanges, conduct roaming information exchanges, or execute multi-AP coordination.

When an AP serves as the RD responder device 420 and sends an indication, the Third-Party Feedback type field may imply the types of traffic described above. A feedback type indication may be included in a multi-STA block acknowledgment or in another control frame when the AP responder device signals a need for transmissions that involve entities other than the RD grant initiator device and responder device. A specific indication frame may be used to notify the RD initiator device 410 of low-latency needs. The AP RD responder device 420 may specify duration, medium time, urgency, and other requirements for downlink transmissions or other activities. According to one embodiment, the RD responder device 420 may return the TXOP to the RD initiator device 410 after completing the event with the second STA 430. A return action may be implemented through transmission of a frame, Null PPDU, quality of service (QoS) Null frame, or a CF-End frame.

According to one embodiment, the RD initiator device 410 may know the direction or type of transmission. In another embodiment, the RD initiator device 410 may not know the specific traffic requested by the RD, although the RD initiator device 410 may be aware of urgency or low-latency requirements. The RD initiator device 410 may include a third-party support field in a control field such as a BAR. An aggregate PPDU with an implicit BAR may also convey that indication. If the RD initiator device 410 agrees to support the RD responder device 420 for downlink or other activities outside the current RD grant, the RD initiator device 410 may set the third-party support field to 1. If support is not granted, the field may be set to 0. When the RD initiator device 410 supports the capability, for example when the third-party support field is set to 1, the RD responder device 420 may begin traffic with the second STA 430. In another embodiment, when an AP serves as the RD responder device 420 and another AP serves as the RD initiator device 410, the enhanced RD may support transmissions required for roaming or multi-AP coordination.

In one embodiment, a second STA 430 may receive data from an RD responder device 420 where the header carries a special information field. The second STA 430 may respond with a special header that remains decodable by the RD initiator device 410. For example, the acknowledgment from the second STA 430, such as the second STA 430, may include a Third-Party Traffic field, PAID, and BSSID. A second STA 430 may be a non-AP STA for peer-to-peer or coexistence use cases. A second STA 430 may also be an AP STA for uplink traffic or other activities. Multiple second STA 430s may participate. One or more of those STAs may associate with the RD initiator device 410 AP. One or more of those STAs may register the RD grant with the RD initiator device 410.

With respect to power saving by the second STA 430, a second STA 430 may act as either an RD responder device 420 or a non-RD responder device 420. The second STA 430 should not enter a sleep or power-save mode while the RD responder device 420 transmits data to the second STA 430. In one embodiment, the RD responder device 420 may conduct a dynamic SCS or an SCS frame exchange with the second STA 430 before the RD TXOP. In another embodiment, the RD responder device 420 may conduct a negotiation procedure or a frame exchange with the second STA 430 during the current TXOP.

Although FIG. 4 illustrates an example enhanced reverse direction grant process 400 with a peer-to-peer grant, various changes may be made to FIG. 4. For example, various components of FIG. 4 could be combined, further subdivided, or omitted and additional components could be added according to particular needs.

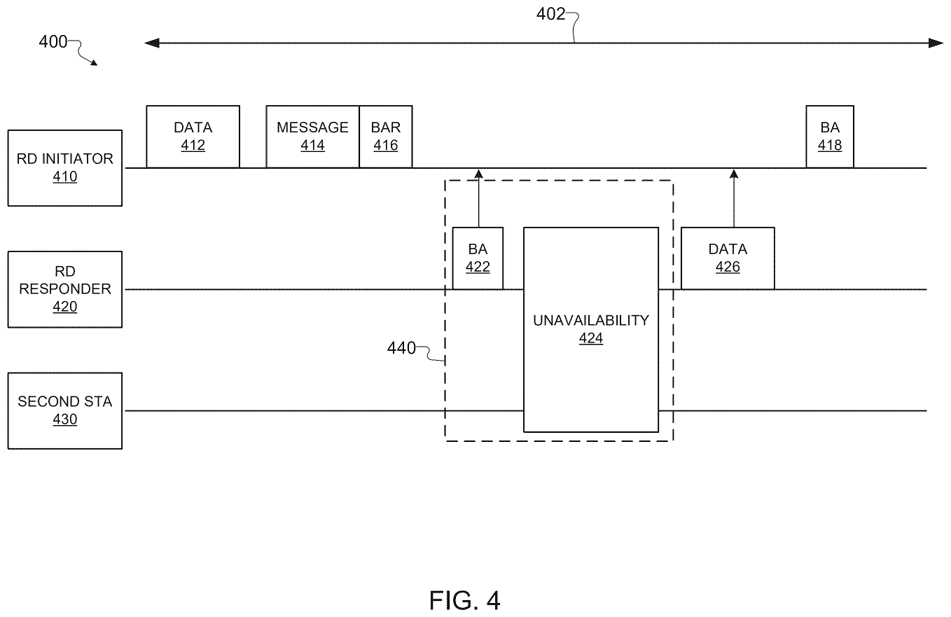

FIG. 5 illustrates an example transmission opportunity (TXOP) 500 enabling peer-to-peer communication according to embodiments of the present disclosure. For ease of explanation, the TXOP 500 will be described as including one or more components of the wireless network 100 of FIG. 1; however, the TXOP 500 could be implemented using any other suitable device or system. The embodiment of the TXOP 500 shown in FIG. 5 is for illustration only. Other embodiments of the TXOP 500 could be used without departing from the scope of this disclosure.

As shown in FIG. 5, the TXOP 500 includes a TXOP duration 502 between a TXOP responder device 510, a TXOP holder 520, and a second STA 530. The TXOP responder device 510 may transmit an ICF 512 to the TXOP holder 520. The ICF 512 may include the P2P policy as well as an indication of multi-user request-to-send (MU-RTS). The TXOP holder 520, upon receipt of the ICF 512, may transmit a CRF 522 to the TXOP responder device 510. Upon receipt of the CRF 522, the TXOP responder device 510 may transmit a frame 514 to the TXOP holder 520 and the TXOP holder 520 may respond with a management frame, such as a management block acknowledgment (MBA) 524. The TXOP responder device 510 may transmit a MU-RTS transmission schedule (TXS) 516 to the TXOP holder 520. Upon receiving the MU-RTS TXS 516, the TXOP holder 520 may initiate a P2P grant 540 with the second STA 530.

When an AP functions as the TXOP responder device 510, the TXOP responder device 510 may state a policy during a negotiation phase for peer-to-peer operation upon receipt of any low-latency indication on P2P from a TXOP holder 520. In a variant, the TXOP responder device 510 may maintain a set of policies that governs subsequent actions. The TXOP responder device 510 may communicate such policies during negotiation phases, within management frames, or in initial control frames.

One policy may allow the TXOP responder device 510 to share a portion of the TXOP with the TXOP holder 520 after receiving the indication from the TXOP holder 520. As the AP, the TXOP responder device 510 may share MU-RTS TXS with the TXOP holder 520. For example, the TXOP 500 illustrates a scenario in which the AP acts as the TXOP responder device 510 and applies such policies. Another policy may permit the TXOP responder device 510 to terminate the TXOP at the request of the TXOP holder 520 for P2P or due to other events. A further policy may authorize use of the RD grant P2P approach discussed above. In addition, the TXOP responder device 510 may adopt a policy that reverses the TXOP role in favor of the TXOP holder 520.

Although FIG. 5 illustrates an example TXOP 500 enabling peer-to-peer communication, various changes may be made to FIG. 5. For example, various components of FIG. 5 could be combined, further subdivided, or omitted and additional components could be added according to particular needs.

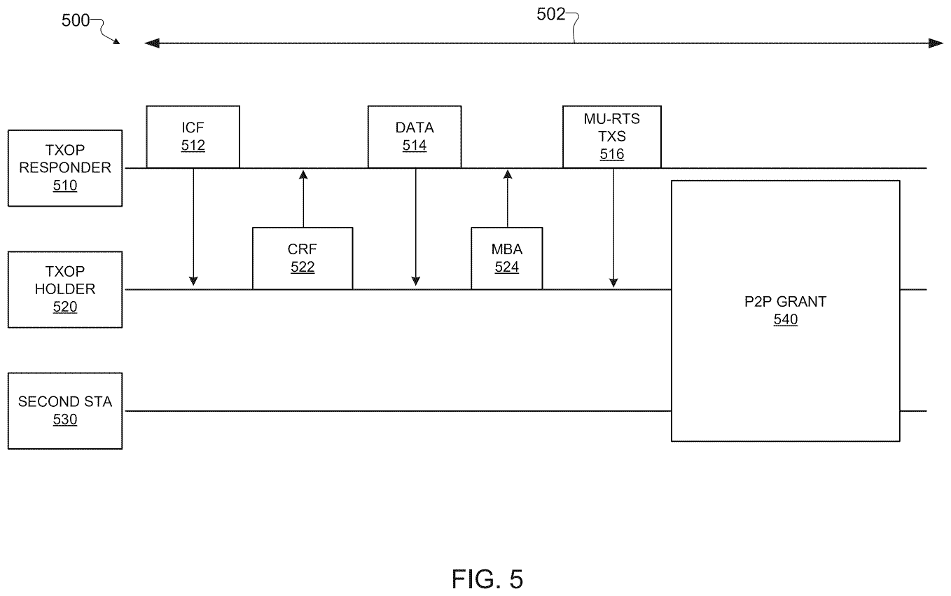

FIG. 6 illustrates an example TXOP 600 enabling peer-to-peer communication according to embodiments of the present disclosure. For ease of explanation, the TXOP 600 will be described as including one or more components of the wireless network 100 of FIG. 1; however, the TXOP 600 could be implemented using any other suitable device or system. The embodiment of the TXOP 600 shown in FIG. 6 is for illustration only. Other embodiments of the TXOP 600 could be used without departing from the scope of this disclosure. The TXOP 600 is configured similarly to the TXOP 500, except as otherwise described.

As shown in FIG. 6, the TXOP 600 includes a TXOP duration 602 between a TXOP responder device 610, a TXOP holder 620, and a second STA 630. The TXOP responder device 610 may transmit a CRF 612 to the TXOP holder 620. The CRF 612 may include the P2P policy as well as an indication of MU-RTS. The TXOP holder 620, upon receipt of the CRF 612, may transmit a ICF 622 to the TXOP responder device 610. Upon receipt of the ICF 622, the TXOP responder device 610 may transmit a low latency indication (LLI) 614 to the TXOP holder 620 and the TXOP holder 620 may respond with a PPDU ICF TXS 626. The TXOP responder device 610 may transmit a 616 to the TXOP holder 620. Upon receiving the 616, the TXOP holder 620 may initiate a DL transmission 640 with the second STA 630.

In this scenario, the TXOP responder device 610 is a non-AP STA, and the AP acts as the TXOP holder 620. The AP may have downlink low-latency traffic to a second STA 630 and may indicate low-latency needs in low-latency indication frames, such as MBA, BA, and control response frames. In one embodiment, the non-AP STA serving as the TXOP responder device 610 may indicate the relevant policy in the initial control frame. In another embodiment, the TXOP responder device 610 may adopt a policy under which a portion of the TXOP is shared with the TXOP holder 620 upon receiving an indication from the responder device; for example, a modified MU-RTS TXS for a non-AP STA may be used, with the non-AP STA sharing MU-RTS TXS with the TXOP holder 620. In a further embodiment, the TXOP responder device 610 may indicate a policy to terminate the TXOP upon request of the TXOP holder 620 request to accommodate an AP event. In yet another embodiment, the TXOP responder device 610 may indicate a policy under which the TXOP role reverses in favor of the TXOP holder 620.

Although FIG. 6 illustrates an example TXOP 600 enabling peer-to-peer communication, various changes may be made to FIG. 6. For example, various components of FIG. 6 could be combined, further subdivided, or omitted and additional components could be added according to particular needs.

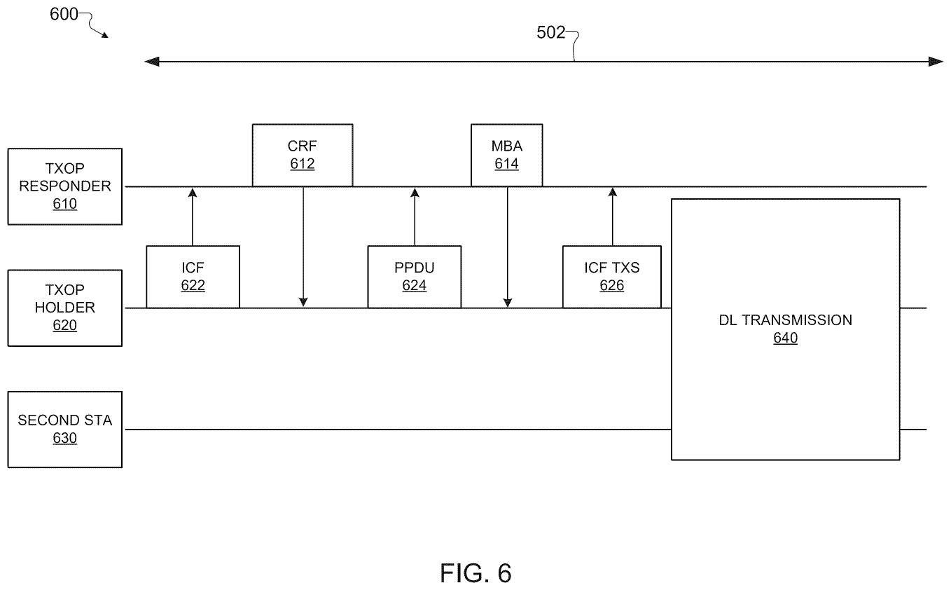

FIG. 7 illustrates an example method 700 for wireless communication performed by a TXOP responder device according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for wireless communication performed by a TXOP responder device could be used without departing from the scope of this disclosure.

As shown in FIG. 7, a frame is received from a TXOP initiator device at step 702. For example, the RD responder device 320 may receive a BAR 316 from the RD initiator device 310. Alternatively, the TXOP holder 520 may receive the ICF 512 from the TXOP responder device 510.

A message is generated including a peer-to-peer (P2P) indication in response to the TXOP initiator device at step 704. For example, the RD responder device 320 may generate a BA 322 that includes a PDP indication. Alternatively, the TXOP holder 520 may generate the CRF 522, which includes a PDP indication.

The message is transmitted to the TXOP initiator device at step 706. For example, the RD responder device 320 transmits the BA 322 to the RD initiator device 310. Alternatively, the TXOP holder 520 transmits the CRF 522 to the TXOP responder device 510.

The method 700 then includes participating in a P2P frame exchange with a station (STA) of a third-party device over a P2P link at step 708. For example, the 320 participates in a P2P frame exchange 340 with a second STA 330, such as a third-party STA to the RD grant process 300. Participating in the P2P frame exchange may include generating a frame during the P2P frame exchange that includes a header configured to be decoded such that the TXOP initiator device and the second STA device are aware of a start of the P2P frame exchange.

Although FIG. 7 illustrates one example method for wireless communication performed by a TXOP responder device, various changes may be made to FIG. 7. For example, while shown as a series of steps, various steps in FIG. 7 could overlap, occur in parallel, occur in a different order, or occur any number of times.

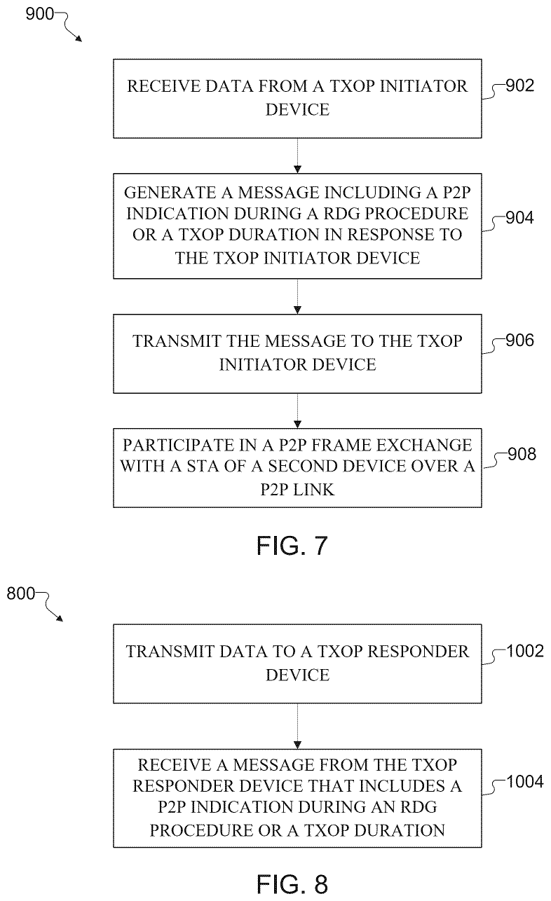

FIG. 8 illustrates an example method 800 for wireless communication performed by a TXOP initiator device according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of wireless communication performed by a TXOP initiator device could be used without departing from the scope of this disclosure.

As shown in FIG. 8, a frame is transmitted to a TXOP responder device at step 802. For example, the RD initiator device RD initiator device 310 may transmit a frame 312 to the RD responder device RD responder device 320. Alternatively, the TXOP responder device 510 may transmit a 512 to the TXOP holder 520. Alternatively, the TXOP responder device 610 may receive a 642 and transmit a 614 to the TXOP holder 620.

A message is received in response to the frame that includes a low latency feedback information from the TXOP responder device at step 804. For example, the RD responder device 320 may transmit a BA 322 that includes a P2P indication to the RD initiator device 310. Alternatively, the RD responder device 420 may transmit a BA 422 that includes the P2P indication to the RD initiator device 410. Alternatively, the TXOP holder 520 may transmit a 524 to the TXOP responder device 510. In response the TXOP responder device 510 may transmit a 516 to the TXOP holder 520 to allow the TXOP holder 520 to participate in a P2P frame exchange. Alternatively, the TXOP holder 620 may transmit an ICF TXS 626 to the TXOP responder device 610 before participating in a P2P frame exchange.

Although FIG. 8 illustrates one example method for wireless communication performed by a TXOP initiator device, various changes may be made to FIG. 8. For example, while shown as a series of steps, various steps in FIG. 8 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

1. A method performed by a transmission opportunity (TXOP) responder device, the method comprising:
receiving a frame from a TXOP initiator device;
generating a message including buffered low latency peer-to-peer (P2P) traffic and a P2P indication during a reverse direction grant (RD grant) procedure or a TXOP duration in response to the TXOP initiator device; and
transmitting the message to the TXOP initiator device.

2. The method of claim 1, wherein the indication includes a request for the pending buffered low latency P2P traffic that includes uplink (UL) low latency traffic to a reverse direction (RD) initiator device, UL low latency traffic to TXOP initiator device, P2P low latency traffic to a RD responder, P2P low latency traffic to the STA of the third-party device other than the TXOP initiator device, a dynamic unavailability operation, or a combination thereof.

3. The method of claim 1, wherein the P2P indication includes a feedback field that indicates a feedback type requested by the TXOP responder device.

4. The method of claim 3, wherein the feedback type indicates the traffic is for a third party or if the traffic is between the TXOP responder device and an associated device, wherein the feedback type is indicated in one or more bits in one or more different frames.

5. The method of claim 1, wherein a multi-STA block acknowledgement (BA) is used to indicate delivery of traffic outside of the RD grant procedure or TXOP that is between the TXOP initiator device and TXOP responder device.

6. The method of claim 1, further comprising:
participating in a P2P frame exchange with the STA of the third-party device over the P2P link, wherein participating in the P2P frame exchange comprises:
generating a frame during the P2P frame exchange that includes a header configured to be decoded such that the TXOP initiator device and the STA of the third-party device are aware of a start of the P2P frame exchange.

7. The method of claim 6, wherein the header includes a provider aggregable identifiers, a basic service set identifier (BSSID), a direction of traffic, a third-party traffic field, or a combination thereof.

8. The method of claim 1, wherein the TXOP initiator device indicates a policy from a list of policies for P2P frame exchange in response to receiving a P2P low latency indication from the TXOP responder device, wherein:
the policy allows the TXOP initiator device to share a portion of the TXOP duration with the TXOP responder device using a multi-user request to send (MU-RTS) transmission (TXS) frame; and
the TXOP initiator device may notify the TXOP responder device of the policy in a negotiation phase, a management frame, in an initial control frame, or a combination thereof.

9. A method performed by a transmission opportunity (TXOP) initiator device, the method comprising:
transmitting a frame to a TXOP responder device; and
receiving a message from the TXOP responder device in response to the frame, wherein the message includes buffered low latency peer-to-peer (P2P) traffic and a P2P low latency indication during a reverse direction grant (RD grant) procedure or a TXOP duration.

10. The method of claim 9, wherein the P2P low latency indication includes a request for traffic that includes uplink (UL) low latency traffic to a reverse direction (RD) initiator device, UL low latency traffic to TXOP initiator device, P2P low latency traffic to an RD responder device, P2P low latency traffic to a STA of a third-party device other than the TXOP initiator device, a dynamic unavailability operation, or a combination thereof.

11. The method of claim 9, the P2P low latency indication includes a feedback field that indicates a feedback type requested by the TXOP responder device.

12. The method of claim 11, wherein the feedback type indicates the traffic is for a third party or if the traffic is between the TXOP responder device and an associated device, wherein the feedback type is indicated in one or more bits in one or more different frames.

13. The method of claim 9, wherein a multi-STA block acknowledgement (BA) is used to indicate delivery of traffic outside of the RD grant procedure or TXOP that is between the TXOP initiator device and TXOP responder device.

14. The method of claim 9, wherein the TXOP initiator device indicates a policy from a list of policies for P2P frame exchange in response to receiving a P2P low latency indication from the TXOP responder device, wherein:
the policy allows the TXOP initiator device to share a portion of the TXOP duration with the TXOP responder device using a multi-user request to send (MU-RTS) transmission (TXS) frame; and
the TXOP initiator device may notify the TXOP responder device of the policy in a negotiation phase, a management frame, in an initial control frame, or a combination thereof.

15. A transmission opportunity (TXOP) responder device, comprising:
at least one processor including processing circuitry; and
memory storing instructions, wherein the instructions, when executed by the at least one processor individually or collectively, cause the electronic device to:
receive data from a TXOP initiator device;
generate a message including a buffered low latency peer-to-peer (P2P) traffic and a P2P low latency indication during a reverse direction grant (RD grant) procedure or a TXOP duration in response to the TXOP initiator device; and
transmit the message to the TXOP initiator device.

16. The TXOP responder device of claim 15, wherein the indication includes a request for traffic that includes uplink (UL) low latency traffic to a reverse direction (RD) initiator device, UL low latency traffic to TXOP initiator device, P2P low latency traffic to an RD responder device, P2P low latency traffic to the STA of the third-party device other than the TXOP initiator device, a dynamic unavailability operation, or a combination thereof.

17. The TXOP responder device of claim 15, wherein the P2P low latency indication includes a feedback field that indicates a feedback type requested by the TXOP responder device.

18. The TXOP responder device of claim 17, wherein the feedback type indicates the traffic is for a third party or if the traffic is between the TXOP responder device and an associated device, wherein the feedback type is indicated in one or more bits in one or more different frames.

19. The TXOP responder device of claim 15, wherein the processor is further configured to cause the TXOP responder device to:
participate in a P2P frame exchange with the STA of a third-party device over a P2P link, wherein the processor, while causing the TXOP responder device to participate in the P2P frame exchange, is further configured to cause the TXOP responder device to:
generate a frame during the P2P frame exchange that includes a header configured to be decoded such that the TXOP initiator device and the STA of the third-party device are aware of a start of the P2P frame exchange.

20. The TXOP responder device of claim 15, wherein the TXOP initiator device indicates a policy from a list of policies for P2P exchange in response to receiving a low latency indication from the TXOP responder device, wherein:
the policy allows the TXOP initiator device to share a portion of the TXOP duration with the TXOP responder device using a multi-user request to send (MU-RTS) transmission (TXS) frame; and
the TXOP initiator device may notify the TXOP responder device of the policy in a negotiation phase, a management frame, in an initial control frame, or a combination thereof.
